(19) United States
(12) Patent Application Publication
(10) Pub. No.: US 2017/0260036 A1
(43) Pub. Date: Sep. 14, 2017

(54) METHOD AND DEVICE FOR FROTHING A LIQUID PRODUCT WITH WHICH BOTTLES ARE FILLED

(71) Applicant: KHS GmbH, Dortmund (DE)

(72) Inventor: Olaf MUSZINSKI, Krongberg (DE)

(21) Appl. No.: 15/103,945

(22) PCT Filed: Oct. 27, 2014
(86) PCT No.: PCT/EP2014/073001

§ 371 Date: Jun. 13, 2016

(30) Foreign Application Priority Data
Dec. 12, 2013 (DE) 10 2013 113 955.8

(51) Int. Cl. B67C 3/22; C12C 13/02

(52) U.S. Cl. CPC B67C 3/222; C12C 13/02

(57) ABSTRACT

A method for frothing beer in a bottle includes introducing, into the bottle of beer, a predetermined quantity of pressurized aqueous chlorine dioxide solution.

### RELATED APPLICATIONS

This is the national stage, under 35 USC 371, of PCT/EP2014/073001, filed on Oct. 27, 2014, which claims the benefit of the Dec. 12, 2013 priority date of German application DE 10-2013-113955.8, the contents of which are herein incorporated by reference.

### FIELD OF INVENTION

The invention relates to filling containers with liquid filling-material, and in particular, to frothing the liquid filling-material.

### BACKGROUND

After a filling machine has filled a container with liquid filling-product, it is often useful to cause a pressurized liquid treatment-medium to impinge upon the container before the container is closed. The container can be a bottle, a barrel, or a similar container. A typical liquid filling-product is beer.

The purpose of this treatment is to froth the liquid filling-product. This frothing expels air from the container's headspace, thus avoiding impairment of shelf life and taste that may result from exposure to oxygen in the air. Known liquid treatment media include heated aqueous solution or water.

Typically, pressurized liquid treatment-medium exits an injection nozzle beneath which pass containers filled with the filling product as they travel between a filling machine and a closure machine. During this process, it is important to take into account product-specific parameters and production-line capacity to cause sufficiently vigorous frothing but without over-frothing. It is also necessary for the liquid treatment-medium to be germ-free.

To achieve microbiological stabilization of the introduced filling product and to increase the foaming effect, with known methods and devices for the frothing of a filling product introduced into bottles or similar containers the liquid treatment-medium is heated, preferably to a temperature of approximately 90° C. However, such heating is energy-intensive. In addition, such a hot medium may cause injury to operating personnel.

### SUMMARY

An object of the invention is to provide a method and a device for frothing liquid filling-material, such as beer, without having to use such a hot treatment-medium.

According to the findings on which the invention is based, a small quantity of chlorine dioxide can be added to the liquid treatment-medium as a disinfection agent in order to achieve a microbiological stabilization of the filling product introduced into the container, in particular a bottle. Small quantities of chlorine dioxide do not have any noticeable influence on the quality of the filling product, in particular the quality of beer. It is particularly advantageous that, depending on the condition of the beer, it is possible to either omit or greatly reduce the heating of the liquid treatment-medium.

A significant aspect of the method according to the invention for the frothing of a filling product, in particular beer, introduced into containers, preferably bottles, can be seen in the fact that an aqueous solution with a proportion of chlorine dioxide or water with a proportion of chlorine dioxide is introduced into the container as the liquid treatment-medium. Particularly advantageously, by impinging on the filling product filled into the bottle, in particular beer, a liquid treatment-medium, preferably water or an aqueous solution with a small proportion of chlorine dioxide, the occurrence of microorganisms can be effectively counteracted, such that the heating of the liquid treatment-medium in the scope known from the prior art can be done away with. Depending on the composition of the filled beer, it may even be possible to do without the heating of the liquid treatment-medium entirely, i.e. the use of a liquid treatment-medium exhibiting room temperature can already be sufficient. This results in a method that is perceptibly improved in terms of energy for the frothing of a liquid filling product, in particular beer.

According to an advantageous embodiment of the method according to the invention, a liquid treatment-medium with a proportion of chlorine dioxide of less than 0.8 ppm is introduced to the liquid filling product comprised in the container. Advantageously, per container, as the predetermined quantity of the liquid treatment-medium, a quantity of less than 0.05 ml, preferably less than 0.02 ml, of the liquid treatment-medium is added. With such a small metering of the chlorine dioxide in the liquid treatment-medium, no noticeable influence will be incurred on the quality of the filling product, in particular on the quality of beer. It is self-explanatory that, when determining the quantity of the liquid treatment-medium necessary for the frothing, requirements must be taken into account such as the size of the container, the temperature of the beverage (e.g. beer), and its frothing behavior.

To further advantage, the liquid treatment-medium is introduced into the containers at a temperature of less than 70° C., preferably at a temperature in the range between 60° C. and 70° C. This allows for a process sequence to be achieved that is even more favorable from the point of view of energy.

As an alternative, for the frothing of beer with an ethanol content of more than 4% of the total beer volume, the liquid treatment-medium is introduced into the containers in the cold state, preferably at room temperature. In this case it is possible to do entirely without a warming or heating of the liquid treatment-medium.

Likewise the object of the invention is a device for carrying out the foresaid method for the frothing of a filling product introduced into containers, preferably bottles, in particular beer, comprising at least one injection device, a controller, and at least one preferably heat-resistant reception container with a liquid treatment-medium contained in it, wherein, controlled by the controller of the reception container, in each case a predetermined quantity of the liquid treatment-medium is drawn off and introduced under pressure into the beverage, such as beer, contained in the container. According to the invention, as the liquid treatment-medium an aqueous solution with a proportion of chlorine dioxide or water with a proportion of chlorine dioxide is provided for. Advantageously, the provision of a heating device, for the heating of the liquid treatment-medium, can be done without entirely, or a heating device with an energy consumption reduced in comparison with the prior art is sufficient.

To further advantage, the proportion of chlorine dioxide is less than 0.8 ppm and the predetermined quantity of the liquid treatment-medium injected into the container is less than 0.05 ml, preferably less than 0.02 ml. With the metering indicated of the proportion of chlorine dioxide in the liquid treatment-medium and the total quantity of treatment-medium introduced, no impairment of the beer quality is appreciable.

Likewise advantageously the liquid treatment-medium exhibits a temperature of less than 70° C., preferably between 60° C. and 70° C. As an alternative, for the frothing of beer with an ethanol content of over 4%, the liquid treatment-medium exhibits a cold state, preferably room temperature.

According to a further embodiment of the device, a portioning device can be provided for the removal, controlled by the controller, of the predetermined quantity of the liquid treatment-medium from the reception container.

According to another further embodiment of the device, a pressure regulation arrangement can be provided for the removal, controlled by the controller, of the predetermined quantity of the liquid treatment-medium from the reception container.

For a further embodiment of the device, provision is made for both a portioning device as well as pressure regulation.

To further advantage, a heating device can be allocated to the reception container for the heating of the liquid treatment-medium contained therein.

### BRIEF DESCRIPTION OF THE DRAWINGS

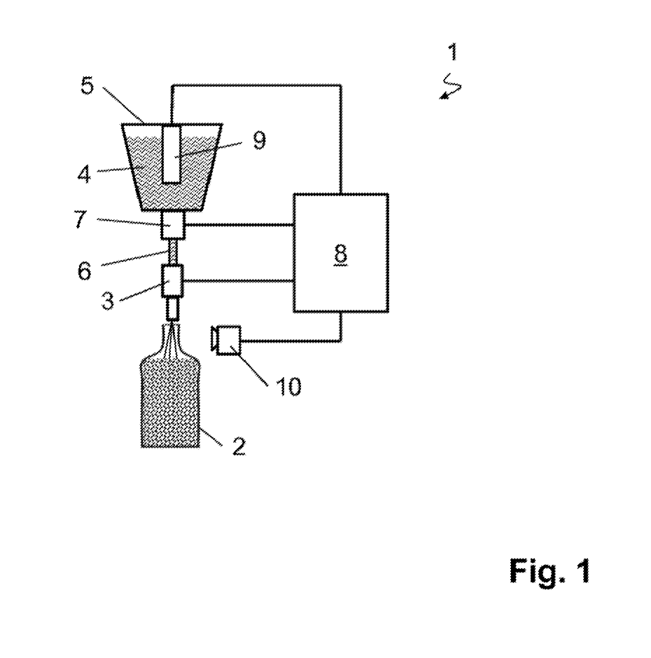

The invention is explained in greater detail hereinafter on the basis of FIG. 1, which is a simplified schematic representation of a device for frothing beer.

### DETAILED DESCRIPTION

FIG. 1 shows a frothing apparatus 1 that is a constituent part of a production line for filling bottles 2 with beer. The frothing apparatus 1 is between a filling machine and a closing.

Once the filling machine fills a bottle 2 with beer, the frothing apparatus 1 applies energy in a controlled manner to form froth. This froth tends to force air out of the bottle 2. The frothing apparatus 1 controls the applied energy so as to avoid over-frothing while still causing frothing of sufficient vigor to drive air out of the bottle 2.

The frothing apparatus 1 uses an injector, such as an injection nozzle 3, to apply the frothing energy. The injection nozzle 3 is provided above a movement path of the upright bottle 2, between a filling machine and a closing machine.

The frothing apparatus 1 includes a heat-resistant reception container 5 that holds liquid treatment-medium 4. A feed line 6 and a portioning device 7 together connect the container 5 to the injection nozzle 3. In some embodiments, the portioning device 7 is a pressure regulator.

Both the injection nozzle 3 and the portioning device 7 connect to a controller 8 that controls delivery of the predetermined quantity of pressurized liquid treatment-medium 4 into the bottle 2. The controller 8 exercises such control by appropriately actuating the portioning device 7.

The frothing apparatus 1 applies an amount of energy that corresponds to the sum of the kinetic energy of the pressurized liquid treatment-medium 4 and the thermal energy of the liquid treatment-medium 4. To keep the energy application into each bottle 2 as constant as possible even with different performance capacities of the production system, i.e. with different numbers of the bottles 2 passing the injection nozzle 3 per unit time, and with the temperature of the liquid treatment-medium 4 constant or essentially constant, the controller 8 regulates the kinetic energy portion of the total applied energy. It does so by an injection pressure as a function of the performance capacity. As a result, during the operation of the frothing apparatus 1, the controller 8 adjusts the quantity of liquid treatment-medium 4 that emerges from the injection nozzle 3 and its injection pressure based at least in part on the capacity of the production line. Preferably, the frothing apparatus 1 introduces the liquid treatment-medium 4 into the bottles 2 at a pressure of between 2 bar and 16 bar.

To froth beer that has been introduced into a bottle 2, the predetermined quantity of the liquid treatment-medium 4 is conducted under pressure to the beer in the bottle 2. In some practices, the liquid treatment-medium 4 is an aqueous solution with a proportion of chlorine dioxide. Preferably, the proportion or concentration of chlorine dioxide is less than 0.8 ppm. This is related to the predetermined quantity of the liquid treatment-medium 4. The predetermined quantity is, for example, less than 0.05 ml, and preferably less than 0.02 ml. As a result, due to the use of water or an aqueous solution in this small quantity, almost no dilution occurs of the beer. Such a low concentration of chlorine dioxide in the water or aqueous solution is sufficient to effectively prevent bacterial growth without noticeably impairing the quality of the liquid filling-product. In fact, test subjects who sampled beer filled according to the method described herein experienced no change in taste.

A heating device 9 in contact with the liquid treatment-medium 4 provides a way to heat the liquid treatment-medium before injecting it. In some practices, the heating device 9 heats the liquid treatment-medium to a temperature of less than 70° C., and preferably to a temperature in the range between 60° C. and 70° C. In some embodiments, the heating device 9, is integrated into the receiving container 5. In those embodiments that include a heating device 9, the controller 8 connects to the heating device 9 and controls its operation.

During frothing of beer with an ethanol content of more than 4%, liquid treatment-medium 4 is introduced in the cold state, preferably at room temperature, into the containers. In such cases, no additional warming of the liquid treatment-medium 4 is required.

Some embodiments also include a sensor device 10 located downstream of the injection nozzle 3 in the transport path of the bottles 2. The sensor device connects to the controller 8 and provides the controller 8 with a signal indicative of an extent of frothing produced by the injection nozzle 3. In response, the controller 8 regulates relevant parameters of the injection process, such as the injection pressure, the predetermined quantity, and the temperature of the liquid treatment-medium 4 in an effort to achieve the correct frothing extent. Embodiments of the sensor device 10 include an optoelectronic sensor device, such as a camera.

In other embodiments, injection nozzles 3 are disposed such that each bottle 2 passes under two or more injection nozzles 3 during the course of the frothing procedure.

Although the foregoing description refers to beer as the liquid filling-material, other liquid filling-materials can also be used.

The invention has been described heretofore by an exemplary embodiment. It is understood that numerous changes and deviations are possible without thereby departing from the inventive concept underlying the invention.

Having described the invention, and a preferred embodiment thereof, what is claimed as new, and secured by Letters Patent is:

1-12. (canceled)

13. A method comprising frothing beer in a bottle, wherein frothing comprising introducing, into said bottle, a predetermined quantity of pressurized aqueous chlorine dioxide solution.

14. The method of claim 13, wherein said aqueous chlorine dioxide solution has a proportion of chlorine dioxide that is less than 0.8 ppm.

15. The method of claim 13, wherein introducing a predetermined quantity of pressurized aqueous chlorine dioxide solution comprises introducing less than 0.05 ml of said of aqueous chlorine dioxide solution.

16. The method of claim 13, wherein introducing a predetermined quantity of said aqueous chlorine dioxide solution comprises introducing less than 0.02 ml of said aqueous chlorine dioxide solution.

17. The method of claim 13, further comprising warming said aqueous chlorine dioxide solution to 70° C.

18. The method of claim 13, further comprising warming said aqueous chlorine dioxide solution to a temperature between 60° C. and 70° C.

19. The method of claim 13, wherein frothing beer comprises frothing beer that has an ethanol content of more than 4%, and wherein introducing, into a bottle of beer, a predetermined quantity of pressurized aqueous chlorine dioxide solution comprises introducing said aqueous chlorine dioxide solution at room temperature.

20. An apparatus for frothing beer in a bottle, said apparatus comprising an injector, a controller, and a heat-resistant container containing an aqueous chlorine dioxide solution, wherein said controller is configured to cause a predetermined quantity of said aqueous chlorine dioxide solution to be drawn from said heat-resistant container and introduced, under pressure, into said beer.

21. The apparatus of claim 20, wherein said aqueous chlorine dioxide solution comprises less than 0.8 ppm of chlorine dioxide.

22. The apparatus of claim 20, wherein said predetermined quantity of aqueous chlorine dioxide solution is less than 0.05 ml.

23. The apparatus of claim 20, wherein said predetermined quantity of aqueous chlorine dioxide solution is less than 0.02 ml.

24. The apparatus of claim 20, wherein said aqueous chlorine dioxide solution is maintained at a temperature between 60° C. and 70° C.

25. The apparatus of claim 20, further comprising a portioning device, said portioning device being configured to draw, under control of said controller, said predetermined quantity of said aqueous chlorine dioxide solution from said heat-resistant container.

26. The apparatus of claim 20, further comprising a heater associated with said heat-resistant container for warming aqueous chlorine dioxide solution container therein.

27. The apparatus of claim 20, wherein said aqueous chlorine dioxide solution is maintained at a temperature of 70° C.
